(19) United States
(12) Patent Application Publication
(10) Pub. No.: US 2024/0119309 A1
(43) Pub. Date: Apr. 11, 2024

(54) METHOD FOR GENERATING COMPUTER-EXECUTABLE CODE FOR IMPLEMENTING AN ARTIFICIAL NEURAL NETWORK

(71) Applicants: STMicroelectronics S.r.l., Agrate Brianza (MB) (IT); STMicroelectronics (Rousset) SAS, Rousset (FR)

(72) Inventors: Laurent Folliot, Gourdon (FR); Marco Lattuada, Legnano (IT); Pierre Demaj, Nice (FR)

(21) Appl. No.: 18/470,798

(22) Filed: Sep. 20, 2023

(30) Foreign Application Priority Data
Oct. 10, 2022 (FR) 2210376

(51) Int. Cl. G06N 3/10; G06F 8/35; G06F 8/41

(52) U.S. Cl. CPC G06N 3/10; G06F 8/35; G06F 8/4434

(57) ABSTRACT

In an embodiments a method includes obtaining a neural network (INN), the neural network having a plurality of neural layers, each layer being capable of being executed according to different implementation solutions and impacting a required memory allocation for the execution of the neural network and/or an execution time of the neural network, defining a maximum execution time threshold of the neural network and/or a maximum required memory allocation threshold for the execution of the neural network, determining an optimal required memory allocation size for the execution of the neural network from possible implementation solutions for each layer of the neural network, determining an optimal execution time of the neural network from the possible implementation solutions for each layer of the neural network and estimating a performance loss or a performance gain in terms of execution time and required memory allocation for each implementation solution of each layer of the neural network.

### CROSS-REFERENCE TO RELATED APPLICATIONS

This application claims the priority benefit of French application no. 2210376, filed on Oct. 10, 2022, which application is hereby incorporated herein by reference.

### TECHNICAL FIELD

Embodiments and implementations relate to artificial neural networks.

### BACKGROUND

Artificial neural networks generally comprise a series of neural layers. Each layer receives input data to which weights are applied and outputs output data after processing by activation functions of the neurons of said layer. This output data is sent to the next layer in the neural network.

The weights are data, more specifically settings, in respect of neurons configurable to obtain correct output data from the layers.

The weights are adjusted during a generally supervised learning phase, particularly by executing the neural network with previously classified data from a reference database as input data.

Once trained, the quantified neural networks are integrated on platforms, particularly on integrated circuits such as microcontrollers.

In particular, it is possible to use an integration software to integrate a quantified neural network in a platform. For example, the integration software STM32Cube.AI and its extension X-CUBE-AI developed by STMicroelectronics are known.

The execution of the neural network can require substantial resources in terms of memory to store the weights and the data generated by the neural network (in particular the activations). The execution of the neural network can also be performed on a high number of processing cycles.

The computer-executable codes of the neural networks can be evaluated according to various performance criteria. A first performance criterion is the allocation of the non-volatile memory used to store the weights of the neural network. A second performance criterion is the allocation of the volatile memory required to store the data generated by the different layers of the neural network during the execution of the neural network. A third performance criterion is the execution time of the neural network.

In order to improve the performances of neural networks, the executable codes of the neural networks can be optimized prior to the integration thereof in an integrated circuit. For example, the executable codes of the neural networks can be optimized to reduce the execution time thereof. The executable codes of the neural networks can also be optimized to reduce the required memory allocation for the execution thereof. Thus, the integration software can particularly be configured to generate an improved, particularly optimized, code of the quantified neural network in terms of execution time and required memory allocation.

It would in theory be preferable to optimize the execution time of the neural network and the required memory allocation for the execution thereof together. Nevertheless, in reality, the optimizations of these performance criteria are generally opposed. Thus, the optimization of the execution time generally gives rise to an increase in the required memory allocation for the execution of the neural network, and the optimization of the required memory allocation generally gives rise to an increase in the execution time of the neural network.

Known solutions for optimizing the executable codes of neural network do not make it possible to obtain a good compromise between the required memory allocation and the execution time of the neural network.

Thus, some solutions choose to optimize the memory allocation while other solutions choose to optimize the execution time instead. However, some users may seek a better compromise between these two performance criteria.

### SUMMARY

Embodiments provide a solution for generating an executable code of a neural network making it possible to improve the compromise between the optimization of the memory allocation and that of the execution time.

Herein, the term “optimization” denotes an improvement in relation to certain performance criteria. This improvement of the neural network does not necessarily correspond to an optimal improvement of the neural network.

Embodiments provide a method for generating a computer-executable code for implementing an artificial neural network including:
obtaining the neural network, the neural network having a plurality of neural layers, each layer being capable of being executed according to different implementation solutions impacting the required memory allocation for the execution of the neural network and/or the execution time of the neural network,
defining a maximum execution time threshold of the neural network and/or a maximum required memory allocation threshold for the execution of the neural network,
determining an optimal required memory allocation size for the execution of the neural network from the possible implementation solutions for each layer of the neural network,
determining an optimal execution time of the neural network from the possible implementation solutions for each layer of the neural network,
estimating a performance loss or gain in terms of execution time and required memory allocation for each implementation solution of each layer of the neural network,
developing an executable code for implementing the optimized neural network by choosing for each layer of the neural network an implementation solution from the possible implementation solutions of this layer according to the performance loss in terms of execution time and/or allocation of this implementation solution with respect to the maximum execution time threshold and/or the maximum memory allocation threshold.

Such a method enables a user of the neural network to define a desired maximum memory allocation size as well as a desired maximum execution time. For example, the user of the neural network can indicate the desired performance criteria via a graphical interface of an integration software or via a command line.

Such a method makes it possible to reduce the required memory allocation at the cost of the execution time, or vice versa, while respecting a maximum execution time or a maximum memory allocation size defined by the user.

Such a method thus makes it possible to find a satisfactory compromise for the user between the execution time and the required memory allocation for the execution of the neural network.

Embodiments provide an optimal required memory allocation size for the execution of the neural network by evaluating the possible placements of the data generated by the layers of the neural network.

Preferably, the optimal execution time of the neural network is determined by choosing for each layer the quickest implementation solution from the possible implementation solutions of this layer.

Advantageously, the estimation of a performance gain or loss in terms of execution time of an implementation solution of a layer is carried out by evaluating the impact of the implementation solution on the execution time of the neural network.

In an advantageous embodiment, the estimation of a performance gain or loss in terms of required memory allocation of the implementation solution of a layer is carried out by evaluating the impact of the implementation solution on the required memory allocation for the execution of the neural network.

Preferably, the method further comprises a compromise cost calculation for each implementation solution, so as to construct a first list ordering the implementation solutions of the layers according to the compromise cost thereof with respect to the required memory allocation and/or a second list ordering the implementation solutions of the layers according to the compromise cost thereof with respect to the execution time.

Advantageously, the executable code for implementing the neural network is developed by taking the implementation solution from said first list and/or said second list in increasing order of compromise cost and comparing the performance loss in terms of execution time and/or allocation of each implementation solution from the list with respect to the maximum execution time threshold and/or the maximum memory allocation threshold.

Further embodiments relates to a computer program product comprising instructions which, when the program is executed by a computer, result in the latter implementing a method as described above. Embodiments also provide a computer-readable medium, on which such a computer program product is saved.

Other embodiments relate to a computer program product comprising instructions which, when the program is executed by a computer, result in the latter implementing the executable code obtained by implementing a method as described above. Yet other embodiments relate to a computer-readable medium, on which such a computer program product is saved.

### BRIEF DESCRIPTION OF THE DRAWINGS

Further advantages and features of the invention will become apparent on studying the detailed description of embodiments, which are in no way restrictive, and the appended drawings wherein:

FIG. 1 illustrates a computer system SYS configured to implement a method for generating a computer-executable code for the implementation of a neural network; and

FIG. 2 illustrates a method for generating a computer-executable code for implementing an artificial neural network.

### DETAILED DESCRIPTION OF ILLUSTRATIVE EMBODIMENTS

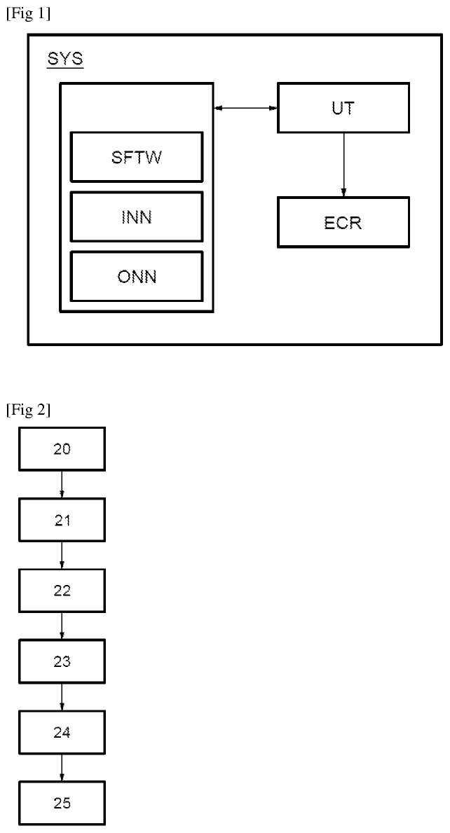

FIG. 1 illustrates a computer system SYS configured to implement a method for generating a computer-executable code for the implementation of a neural network, as described hereinafter with reference to FIG. 2. The system SYS can be a computer for example.

The system SYS comprises a non-volatile memory MNV and a processing unit UT. The memory MNV is configured to store the previously trained neural network INN and an executable code ONN, particularly optimized, generated from the neural network INN by implementing the generation method described hereinafter.

The non-volatile memory is also configured to store the integration software SFTW. This integration software SFTW is a computer program which comprises instructions which when the integration software SFTW is executed by the processing unit UT, result in the latter implementing the generation method described hereinafter.

The processing unit UT is therefore configured to execute the integration software SFTW and thus implement the generation method described hereinafter.

The computer system SYS comprises a screen ECR configured to display information for the user, particularly via a graphical interface of the integration software SFTW.

FIG. 2 illustrates an implementation of a method for generating a computer-executable code for implementing an artificial neural network INN. Such a method can be implemented by a computer system SYS as described above, particularly by the processing unit UT.

The method includes a step 20 of obtaining a neural network INN. In this step 20, a user inputs the artificial neural network INN for the integration software SFTW. The integration software SFTW is configured to carry out an optimization of the artificial neural network INN in order to integrate the optimized executable code ONN of the neural network obtained on a platform, particularly a microcontroller. Such a platform will then be able to execute the optimized executable code ONN of the neural network.

The artificial neural network INN comprises a series of neural layers. In some cases, the artificial neural network INN can have several parallel branches wherein the layers of the neural network are distributed. Each layer receives input data to which weights of the layer are applied. Each layer outputs output data after processing by activation functions of the neurons of said layer. This output data is sent to the next layer in the neural network.

Each layer of the neural network can be implemented (i.e. used) according to different implementation solutions. Each implementation solution impacts the required memory allocation for the execution of the neural network and/or the execution time of the neural network. The method for generating the executable code enables a user to seek implementation solutions of each layer of the neural network which can meet the performance criteria desired by the user in terms of required memory allocation and execution time of the neural network.

In order to generate the executable code of the neural network INN supplied by the user, the method firstly includes a step 21 of determining an optimal required memory allocation size for the execution of the neural network. In particular, the execution of the neural network requires storage of the data generated by each layer of the neural network. This data is generally stored in a volatile memory, particularly a RAM memory (acronym of “Random Access Memory”).

The optimal memory allocation size can be determined by different methods. More specifically, the optimal memory allocation size can be determined by identifying the optimal memory placements of the data blocks generated by the different layers of the neural network. For example, the optimal memory allocation size can be determined by implementing the method described in the French patent application with application number No. 20.04337, which is incorporated herein by reference in its entirety. It is thus possible to obtain for each layer of the neural network an implementation solution enabling a minimal memory allocation. This implementation solution is referred to as memory allocation optimization solution.

The method also comprises a first determination step 22 wherein an optimal execution time of the neural network is estimated. In particular, the execution time of the neural network corresponds to the time required to execute all of the layers of the neural network. The optimal execution time can be determined by applying execution optimization methods on each layer of the neural network. It is for example possible to merge pooling layers or perform a heap overlay. It is thus possible to obtain an implementation solution of the neural network enabling a minimal execution time of the neural network. This minimal execution time being obtained by choosing the quickest implementation solution for each layer of the neural network.

These implementation solutions are referred to as execution time optimization solutions. Such implementation solutions can nevertheless give rise to an increase in the required memory allocation for the execution of the neural network with respect to the implementation solutions enabling a minimal memory allocation.

Thus, the method then comprises a determination step 23 wherein a performance gain or loss in terms of execution time and required memory allocation for the execution of the neural network is estimated for each implementation solution of each layer of the neural network.

In particular, the gain or loss in terms of execution time of an implementation solution is estimated by calculating the execution time for each implementation solution. More specifically, the execution time for each implementation solution can be calculated from the number of multiplications and accumulations carried out for each layer and/or from the type of this layer.

The execution time for each implementation solution can also be calculated from machine learning methods, particularly using a linear regression model.

The gain or loss in terms of memory allocation of an implementation solution can be estimated approximately by taking into consideration the effect of each implementation solution of a layer taken in isolation. It is also possible to estimate such a gain or such a loss by implementing the method described above of placing data blocks generated by the layers of the neural network taking the implementation solution studied as the constraint.

The method comprises a compromise cost calculation step 24. In this step 24, for each layer and for each implementation solution of this layer which does not correspond to an implementation solution enabling a minimal memory allocation, a cost of improving the execution time is calculated.

This cost of improving the execution time is expressed by the ratio between the loss in terms of required memory allocation and the gain in terms of execution time. A list is created ordering the layers according to their cost of improving the execution time from the least costly layer.

Furthermore, in this step 24, for each layer and for each implementation solution of this layer which does not correspond to an implementation solution enabling a minimal memory execution time, a cost of improving the required memory allocation is calculated. This cost of improving the memory allocation is expressed by the ratio between the loss in terms of execution time and the gain in terms of required memory allocation. A list is created ordering the layers according to their cost of improving the memory allocation from the least costly layer.

The method also comprises a step 25 of developing an optimized executable code of the neural network. In this step 25, the integration software decides which implementation solution to implement for each layer of the neural network.

To do this, the integration software proposes different optimization modes to the user. The user chooses the optimization mode to be implemented according to the performance criteria desired by the user. In particular, the choice can be made by the user via a graphical interface of the integration software displayed on the screen ECR of the computer system SYS.

The choice can be also be made via a code line that can be interpreted by the integration software. The choice of the optimization mode relates to options affecting the different performance criteria (required memory allocation for the execution of the neural network and execution time of the neural network).

A first optimization mode enables the user to best optimize the required memory allocation for the execution of the neural network.

In this first optimization mode, the layers of the neural network are initially configured according to the memory allocation optimization solution.

Then, the execution time optimization solution is tested for each layer of the neural network, in order to determine whether this solution increases the required memory allocation or not.

If the solution for optimizing the execution time of a layer does not increase the required memory allocation, then this layer is implemented according to the execution time optimization solution.

Conversely, if the solution for optimizing the execution time of a layer increases the required memory allocation, then this layer is implemented according to the memory allocation optimization solution.

Preferably, the execution time optimization solution is tested for each layer in the list ordering the layers according to their cost of improving the execution time from the least costly layer.

A second optimization mode enables the user to best optimize the execution time for the execution of the neural network.

In this second optimization mode, all the layers of the neural network are implemented according to the execution time optimization solution.

A third optimization mode enables the user to optimize the execution time of the neural network, by taking a maximum required memory allocation threshold for the execution of the neural network defined by the user as a constraint.

In this third optimization mode, the layers of the neural network are initially configured according to the memory allocation optimization solution.

Then, the execution time optimization solution is tested for each layer of the neural network, in order to determine whether this solution increases the required memory allocation beyond a threshold predefined by the user or not.

If the solution for optimizing the execution time of a layer does not increase the required memory allocation beyond a threshold predefined by the user, then this layer is implemented according to the execution time optimization solution and the required memory allocation is updated.

Conversely, if the solution for optimizing the execution time of a layer increases the required memory allocation beyond a threshold predefined by the user, then this layer is implemented according to the memory allocation optimization solution.

Preferably, the execution time optimization solution is tested for each layer in the list ordering the implementation solutions of the layers according to their cost of improving the execution time from the least costly layer.

A fourth optimization mode enables the user to optimize the required memory allocation for the execution of the neural network, by taking a maximum execution time threshold of the neural network defined by the user as a constraint.

In this fourth optimization mode, the layers of the neural network are initially configured according to the execution time optimization solution. Then, the memory allocation optimization solution is tested for each layer of the neural network, in order to determine whether this solution increases the execution time of the neural network beyond a threshold predefined by the user or not.

If the solution for optimizing the memory allocation of a layer does not increase the execution time of the neural network beyond a threshold predefined by the user, then this layer is implemented according to the memory allocation optimization solution and the execution time of the neural network is updated.

Conversely, if the solution for optimizing the memory allocation of a layer increases the execution time of the neural network beyond a threshold predefined by the user, then this layer is implemented according to the execution time optimization solution.

Preferably, the memory allocation optimization solution is tested for each layer in the list ordering the layers according to their cost of improving the memory allocation from the least costly layer.

The optimized executable code of the neural network developed by the integration software is then stored in the non-volatile memory MNV of the computer system SYS.

Such a method for generating an executable code for implementing a neural network has the advantage of proposing different optimization modes to the user. The user can thus choose the optimization mode to be implemented according to the optimization criteria defined by the user. In particular, the user can prefer to optimize required memory allocation for the execution of the neural network or the execution time of the neural network.

In particular, the first optimization mode enables the user to optimize the executable code for implementing the neural network so as to reduce the required memory allocation for the execution of the neural network as much as possible.

The second optimization mode enables the user to optimize the executable code for implementing the neural network so as to reduce the execution time of the neural network as much as possible.

The third optimization mode enables the user to make a compromise between required memory allocation and execution time by defining a desired maximum memory allocation for the optimization of the neural network. Indeed, the third optimization mode makes it possible to optimize the executable code for implementing the neural network in terms of execution time while the required memory allocation is less than a maximum threshold.

The fourth optimization mode enables the user to make a compromise between required memory allocation and execution time by defining a desired maximum execution time for the optimization of the neural network. Indeed, the fourth optimization mode makes it possible to optimize the executable code for implementing the neural network in terms of required memory allocation while the execution time of the neural network is less than a maximum threshold.

What is claimed is:

1. A method for generating a computer-executable code for implementing an artificial neural network, the method comprising:
obtaining a neural network (INN), the neural network having a plurality of neural layers, each layer being capable of being executed according to different implementation solutions and impacting a required memory allocation for the execution of the neural network and/or an execution time of the neural network;
defining a maximum execution time threshold of the neural network and/or a maximum required memory allocation threshold for the execution of the neural network;
determining an optimal required memory allocation size for the execution of the neural network from possible implementation solutions for each layer of the neural network;
determining an optimal execution time of the neural network from the possible implementation solutions for each layer of the neural network;
estimating a performance loss or a performance gain in terms of execution time and required memory allocation for each implementation solution of each layer of the neural network; and
developing an executable code (ONN) for implementing the INN by choosing, for each layer of the INN, an implementation solution from possible implementation solutions of this layer according to the performance loss in terms of execution time and/or allocation of this implementation solution with respect to the maximum execution time threshold and/or the maximum memory allocation threshold.

2. The method according to claim 1, wherein the optimal required memory allocation size for the execution of the neural network is determined by evaluating possible placements of data generated by the layers of the neural network.

3. The method according to claim 1, wherein the optimal execution time of the neural network is determined by choosing, for each layer, the quickest implementation solution from the possible implementation solutions of this layer.

4. The method according to claim 1, wherein estimating the performance gain or loss in terms of execution time of an implementation solution of a layer comprises evaluating the impact of the implementation solution on the execution time of the neural network.

5. The method according to claim 1, wherein estimating the performance gain or loss in terms of required memory allocation of an implementation solution of a layer comprises evaluating the impact of the implementation solution on the required memory allocation for the execution of the neural network.

6. The method according to claim 1, further comprising calculating a compromise cost for each implementation solution so as to construct a first list ordering the implementation solutions of the layers according to the compromise cost thereof with respect to the required memory allocation and/or a second list ordering the implementation solutions of the layers according to the compromise cost thereof with respect to the execution time.

7. The method according to claim 6, wherein the executable code for implementing the neural network is developed by taking the implementation solution from the first list and/or the second list in increasing order of the compromise cost and comparing the performance loss in terms of execution time and/or allocation of each implementation solution from the list with respect to the maximum execution time threshold and/or the maximum memory allocation threshold.

8. A non-transitory computer-readable media storing instructions, which, when executed by one or more processors, cause the one or more processors to implement the method according to claim 1.

9. A device comprising:
a memory storing instructions according to claim 1; and
one or more processors electrically connected to the memory,
wherein the one or more processors are configured to execute the instructions.

10. A method for generating a computer-executable code for implementing an artificial neural network, the method comprising:
obtaining a neural network (INN), the neural network having a plurality of neural layers, each layer being capable of being executed according to different implementation solutions and impacting a required memory allocation for the execution of the neural network and an execution time of the neural network;
defining a maximum execution time threshold of the neural network and a maximum required memory allocation threshold for the execution of the neural network;
determining an optimal required memory allocation size for the execution of the neural network from possible implementation solutions for each layer of the neural network;
determining an optimal execution time of the neural network from the possible implementation solutions for each layer of the neural network;
estimating a performance loss or a performance gain in terms of execution time and required memory allocation for each implementation solution of each layer of the neural network; and
developing an executable code (ONN) for implementing the INN by choosing, for each layer of the INN, an implementation solution from a possible implementation solutions of this layer according to the performance loss in terms of execution time and allocation of this implementation solution with respect to the maximum execution time threshold and the maximum memory allocation threshold.

11. The method according to claim 10, wherein the optimal required memory allocation size for the execution of the neural network is determined by evaluating possible placements of data generated by the layers of the neural network.

12. The method according to claim 10, wherein the optimal execution time of the neural network is determined by choosing, for each layer, the quickest implementation solution from the possible implementation solutions of this layer.

13. The method according to claim 10, wherein estimating the performance gain or loss in terms of execution time of an implementation solution of a layer comprises evaluating the impact of the implementation solution on the execution time of the neural network.

14. The method according to claim 10, wherein estimating the performance gain or loss in terms of required memory allocation of the implementation solution of a layer comprises evaluating the impact of the implementation solution on the required memory allocation for the execution of the neural network.

15. The method according to claim 10, further comprising calculating a compromise cost for each implementation solution so as to construct a first list ordering the implementation solutions of the layers according to the compromise cost thereof with respect to the required memory allocation and a second list ordering the implementation solutions of the layers according to the compromise cost thereof with respect to the execution time.

16. The method according to claim 15, wherein the executable code for implementing the neural network is developed by taking the implementation solution from the first list and the second list in increasing order of the compromise cost and comparing the performance loss in terms of execution time and allocation of each implementation solution from the list with respect to the maximum execution time threshold and the maximum memory allocation threshold.

17. A non-transitory computer-readable media storing instructions, which, when executed by one or more processors, cause the one or more processors to implement the method according to claim 10.

18. A device comprising:
a memory storing instructions according to claim 10; and
one or more processors electrically connected to the memory,
wherein the one or more processors are configured to execute the instructions.
